(19) United States
(12) Patent Application Publication
(10) Pub. No.: US 2026/0024174 A1
(43) Pub. Date: Jan. 22, 2026

(54) IMAGE RECONSTRUCTION MODEL TRAINING AND IMAGE RECONSTRUCTION

(71) Applicant: MASHANG CONSUMER FINANCE CO., LTD., Chongqing (CN)

(72) Inventors: Chao LI, Chongqing (CN); Guowei LYU, Chongqing (CN); Chengyi WEI, Chongqing (CN); Xu LI, Chongqing (CN); Jingxuan HUANG, Chongqing (CN)

(73) Assignee: MASHANG CONSUMER FINANCE CO., LTD., Chongqing (CN)

(21) Appl. No.: 19/236,709

(22) Filed: Jun. 12, 2025

(30) Foreign Application Priority Data
Jul. 17, 2024 (CN) 202410956635.2

(51) Int. Cl. G06T 5/60; G06T 5/20; G06T 5/50

(52) U.S. Cl. CPC G06T 5/60; G06T 5/20; G06T 5/50; G06T 2207/20081; G06T 2207/20084; G06T 2207/20221

(57) ABSTRACT

In a method for training an image reconstruction model, convolution processing is performed on a first image through the image reconstruction model to obtain at least one first intermediate image. Pixel recombination is performed on the at least one first intermediate image to obtain a reconstructed image of the first image. The image reconstruction model is trained based on the reconstructed image and a second image to obtain a target image reconstruction model. A resolution of the second image is higher than a resolution of the first image. The first image and the second image are based on a same first sample image.

### RELATED APPLICATION

The present application claims priority to Chinese Patent Application No. 202410956635.2 filed on Jul. 17, 2024, which is hereby incorporated by reference in its entirety.

### FIELD OF THE TECHNOLOGY

This application relates to the field of image processing technologies, including a training method for an image reconstruction model and an image reconstruction method.

### BACKGROUND OF THE DISCLOSURE

With rapid development of digital technologies, video calling has become an important requirement for daily communication, work, and entertainment of people. However, in a weak network or mobile communication scenario, due to factors such as bandwidth limitation and network fluctuation, real-time video transmission faces a significant challenge. Especially in an environment with a poor network condition, quality of real-time video transmission is highly susceptible to an impact, resulting in a blurred image and an increased delay, thereby severely affecting user experience.

Therefore, image reconstruction needs to be performed on a received video image, to improve video image quality. How to efficiently and accurately perform image reconstruction to improve image resolution and reduce delay has become a major focus of current research.

### SUMMARY

Aspects of this disclosure include a training method for an image reconstruction model, an image reconstruction method, and an apparatus for training an image reconstruction model to implement super-resolution reconstruction of an image in a high-efficiency, high-quality, and lightweight manner, to obtain a high-resolution video image and details. In addition, the image reconstruction process consumes fewer resources.

Examples of technical solutions of this disclosure may be implemented as follows:

An aspect of this disclosure provides a method for training an image reconstruction model. Convolution processing is performed on a first image through the image reconstruction model to obtain at least one first intermediate image. Pixel recombination is performed on the at least one first intermediate image to obtain a reconstructed image of the first image. The image reconstruction model is trained based on the reconstructed image and a second image to obtain a target image reconstruction model. A resolution of the second image is higher than a resolution of the first image. The first image and the second image are based on a same first sample image.

An aspect of this disclosure provides an image reconstruction method. A to-be-processed image is obtained. The to-be-processed image is input into a target image reconstruction model. A reconstructed image from the target image reconstruction model is obtained based on the to-be-processed image. A resolution of the reconstructed image is higher than a resolution of the to-be-processed image. The target image reconstruction model is trained by performing convolution processing on a first image through an image reconstruction model to obtain at least one first intermediate image. The target image reconstruction model is trained by performing pixel recombination on the at least one first intermediate image to obtain a reconstructed image of the first image. The target image reconstruction model is trained by training the image reconstruction model based on the reconstructed image and a second image to obtain the target image reconstruction model. A resolution of the second image is higher than a resolution of the first image. The first image and the second image are based on a same first sample image.

An aspect of this disclosure provides an information processing apparatus. The apparatus includes processing circuitry configured to obtain a to-be-processed image. The processing circuitry is configured to input the to-be-processed image into a target image reconstruction model. The processing circuitry is configured to obtain a reconstructed image from the target image reconstruction model based on the to-be-processed image. A resolution of the reconstructed image is higher than a resolution of the to-be-processed image. The target image reconstruction model is trained by performing convolution processing on a first image through an image reconstruction model to obtain at least one first intermediate image. The target image reconstruction model is trained by performing pixel recombination on the at least one first intermediate image to obtain a reconstructed image of the first image. The target image reconstruction model is trained by training the image reconstruction model based on the reconstructed image and a second image to obtain the target image reconstruction model. A resolution of the second image is higher than a resolution of the first image. The first image and the second image are based on a same first sample image.

Aspects of this disclosure can have the following beneficial effects.

With a low-resolution first image and a high-resolution second image as training data, image reconstruction is performed on the first image through the image reconstruction model, to obtain the reconstructed image, and the image reconstruction model is trained based on the reconstructed image and the second image. Therefore, the image reconstruction model can more fully learn a mapping relationship from a low-resolution image to a high-resolution image, and image reconstruction of an image having any resolution can be implemented, to output a high-quality image. Based on this, the image reconstruction model is of a full convolution structure, and mapping from a low-resolution image to a high-resolution image is implemented through convolution processing and pixel recombination of an input image. Because the convolution structure is simple and involves fewer parameters, an image reconstruction process based on a convolution structure has the advantages of high efficiency, low computing complexity, less resource consumption, and light weight. Therefore, the trained target image reconstruction model not only can quickly reconstruct a high-resolution image to meet a requirement on real-time performance, but also consumes fewer resources in an image reconstruction process, is not limited by an application scenario, can not only be run on a server, but also be run on a mobile device with limited computing resources, and can be applied to a special running environment with limited performance, such as a mobile terminal.

### BRIEF DESCRIPTION OF THE DRAWINGS

The accompanying drawings described herein are intended to provide a further understanding of this disclosure, and form part of this disclosure. Aspects of this disclosure and descriptions thereof are intended to explain this disclosure, and do not constitute any inappropriate limitation to this disclosure. In the accompanying drawings:

FIG. 1 is a schematic flowchart of a training method for an image reconstruction model according to an aspect of this disclosure;

FIG. 2 is a schematic diagram of a method for obtaining a first image according to an aspect of this disclosure;

FIG. 3 is a schematic diagram of a method for obtaining a first feature image according to an aspect of this disclosure;

FIG. 4 is a schematic diagram of a method for determining a second convolution subkernel according to an aspect of this disclosure;

FIG. 5 is a schematic structural diagram of an image reconstruction model according to an aspect of this disclosure;

FIG. 6 is a schematic structural diagram of a super-resolution network according to an aspect of this disclosure;

FIG. 7 is a schematic structural diagram of a convolutional layer according to an aspect of this disclosure;

FIG. 8 is a schematic structural diagram of an image reconstruction apparatus according to an aspect of this disclosure;

FIG. 9 is a schematic structural diagram of a target image reconstruction model according to an aspect of this disclosure;

FIG. 10 is a schematic diagram of a method for obtaining a third feature image according to an aspect of this disclosure;

FIG. 11 is a schematic structural diagram of an apparatus for training an image reconstruction model according to an aspect of this disclosure;

FIG. 12 is a schematic structural diagram of an image reconstruction apparatus according to an aspect of this disclosure; and

FIG. 13 is a schematic structural diagram of an electronic device according to an aspect of this disclosure.

### DETAILED DESCRIPTION

To make the objective, technical solutions, and advantages of this disclosure clearer, the technical solutions of this disclosure are described below with reference to the accompanying drawings. The described aspects are only some aspects rather than all the aspects of this disclosure. Other aspects based on the aspects of this disclosure shall fall within the protection scope of this disclosure. Further, the descriptions of the terms are provided as examples only and are not intended to limit the scope of the disclosure.

The terms such as “first” and “second” in this specification and the claims are intended to distinguish between similar objects, but are not intended to describe a specific sequence or order. It should be understood that data used in such a way is interchangeable where appropriate so that the aspects of this disclosure can be implemented in an order other than those illustrated or described herein. In addition, “and/or” in this specification and the claims indicates at least one of connected objects, and the character “/” indicates an “and/or” relationship between associated objects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

As described in the background, in a weak network or mobile communication scenario, limited by a network condition, video transmission quality is highly susceptible to an impact, resulting in a blurred image and an increased delay, thereby severely affecting user experience.

A super resolution (SR) technology provides an innovative solution to this problem, so that a high-resolution image can be reconstructed from a low-resolution image, thereby improving, and in some cases significantly improving, image quality and details. This technology can break a strong dependency relationship between quality of conventional video transmission and a network condition, and can still ensure quality of video calling and content transmission even in a case in which a bandwidth is limited or a network is unstable.

Although the super resolution technology has advantages, the super resolution technology still faces many problems and challenges in an aspect of implementing a real-time super resolution.

(1) Excessive computing resource consumption leads to limited application scenarios of the above-mentioned super resolution technology. For example, a computing capability, an internal memory, and a battery life of a mobile device are far less than those of a server and a personal computer. This limits the possibility that the above-mentioned super resolution technology can run on the mobile device. In addition, a high computing requirement significantly increases power consumption of a running device, and affects endurance of the running device.

(2) It is difficult to meet a requirement on real-time performance. A real-time video calling scenario has a relatively low tolerance for a delay. This means that image reconstruction based on the super resolution technology needs to be completed in an extremely short time, which imposes a higher requirement on image reconstruction efficiency. The super resolution technology in the related technology has a high algorithm complexity and a long processing time, so that it is difficult to meet the requirement on real-time performance.

(3) A computational operation limitation occurs. Currently, most devices, especially mobile devices, do not support computational operations involved in the super resolution technology well.

(4) Transmission scenario optimization is lacked. Under a weak network transmission condition, a video stream is usually processed into a low bit rate for transmission, and an additional image quality loss is caused during coding and compression. However, the super resolution technology in the related technology lacks compensation for a coding loss.

In view of this, an aspect of this disclosure takes aspects such as algorithm efficiency, computing resource optimization, and power consumption management into comprehensive consideration, and provides a training method for an image reconstruction model. With a low-resolution first image and a high-resolution second image as training data, image reconstruction is performed on the first image through the image reconstruction model, to obtain a reconstructed image, and the image reconstruction model is trained based on the reconstructed image and the second image. Therefore, the image reconstruction model can more fully learn a mapping relationship from a low-resolution image to a high-resolution image, and image reconstruction of an image having any resolution can be implemented, to output a high-quality image. Based on this, the image reconstruction model is of a full convolution structure, and mapping from a low-resolution image to a high-resolution image is implemented through convolution processing and pixel recombination of an input image. Because the convolution structure is simple and involves fewer parameters, an image reconstruction process based on a convolution structure has the advantages of higher efficiency, lower computing complexity, less resource consumption, and lighter weight. Therefore, a trained target image reconstruction model not only can quickly reconstruct a high-resolution image to meet a requirement on real-time performance, but also consumes fewer resources in an image reconstruction process, is not limited by an application scenario, can not only be run on a server, but also be run on a mobile device with limited computing resources, and can be applied to a special running environment with limited performance such as a mobile terminal.

An aspect of this disclosure further provides an image reconstruction method. Any image is reconstructed through the target image reconstruction model trained through the above-mentioned training method, to obtain a high-resolution image. Because the target image reconstruction model has a full convolution structure, mapping from a low-resolution image to a high-resolution image is implemented through convolution processing and pixel recombination of an input image. This has the advantages of high efficiency, low computing complexity, less resource consumption, and light weight. This can not only meet a requirement on real-time performance, but also be applied to a special running environment with limited performance, such as a mobile terminal.

It should be noted that the training method for an image reconstruction model and the image reconstruction method according to the aspects of this disclosure may be applied to various scenarios having an image reconstruction requirement, for example, including but not limited to satellite and aerial image processing, security monitoring, medical image enhancement, digital film restoration, and specific applications of consumer electronics.

It should be understood that the training method for an image reconstruction model and the image reconstruction method according to the aspects of this disclosure may be performed by an electronic device. The electronic device herein may include a terminal device, for example, a smartphone, a tablet computer, a notebook computer, a desktop computer, an intelligent voice interaction device, an intelligent appliance, a smartwatch, an on-board terminal, or an aircraft. Alternatively, the electronic device may further include a server, for example, an independent physical server, or may be a server cluster or distributed system including a plurality of physical servers, or may be a cloud server that provides a cloud computing service.

The following describes technical solutions provided in the aspects of this disclosure in further detail with reference to the accompanying drawings.

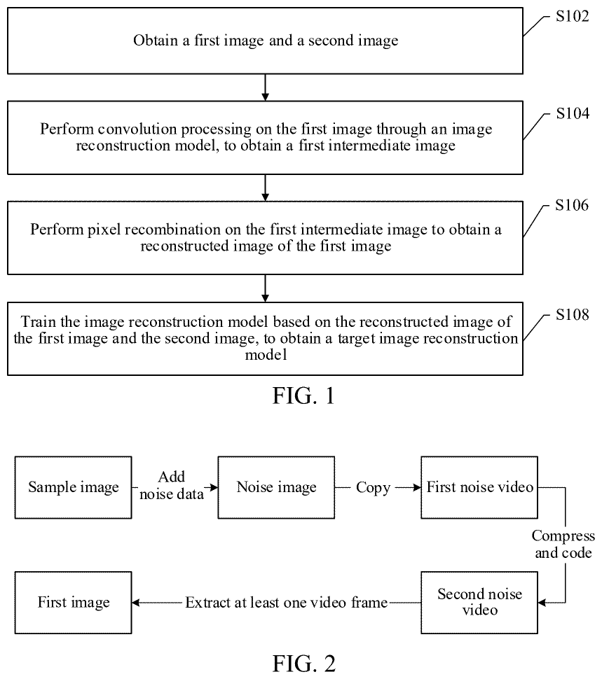

FIG. 1 is a schematic flowchart of a training method for an image reconstruction model according to an aspect of this disclosure. The method includes the following steps.

S102: Obtain a first image and a second image.

The first image and the second image are obtained based on a same image. A resolution of the second image is higher than a resolution of the first image. For example, the first image may be a low-resolution image obtained by degrading a sample image, and the second image is a high-resolution image obtained by enhancing the sample image. The sample image may be a video frame extracted from a high-definition video. During actual application, the sample image is a red green blue (RGB) image, and the first image and the second image generated thereby are also RGB images.

The sample image may be degraded through various degradation technologies. This is not limited in this aspect of this disclosure. In an implementation, as shown in FIG. 2, the first image is obtained by processing the sample image in the following manner: noise data is added to the sample image, to obtain a noise image; the noise image is copied to obtain a first noise video; the first noise video is compressed and coded to obtain a second noise video; and the first image is generated based on at least one video frame in the second noise video.

For example, the noise data may be added to the sample image in the following manner. The sample image is blurred through a Gaussian kernel function of a random parameter, and then noise adding is performed on a blurred sample image, with a noise strength being random every time. Then, an image whose specified size is a multiple (for example, ½, ⅓, or ¼) is generated through a bilinear difference, as a noise image.

Further, the noise image is converted into a first noise video by a frame repetition technology. Then the first noise video is coded and compressed through H264 coding, to obtain a second noise video having a low bit rate and a low resolution. Finally, an intermediate frame is extracted from the second noise video as the first image.

The sample image may be enhanced through various data enhancement technologies. This is not limited in this aspect of this disclosure. In an implementation, the sample image is sharpened and enhanced by a non-sharpening masking technique, to obtain the second image.

S104: Perform convolution processing on the first image through the image reconstruction model, to obtain a first intermediate image. For example, convolution processing is performed on a first image through the image reconstruction model to obtain at least one first intermediate image.

The image reconstruction model has a super-resolution image reconstruction capability, and can reconstruct a low-resolution image into a high-resolution image. The convolution processing is performed on the first image through the image reconstruction model, so that effective features can be extracted from the first image, to obtain the first intermediate image, so as to subsequently perform high-quality image reconstruction.

In an implementation, to ensure that the obtained first intermediate image includes effective image features to provide data support for subsequently reconstructing a high-resolution image, color space conversion may be performed on the first image, and then targeted convolution processing is performed for different image channels. Specifically, the first intermediate image includes a first-channel image and a first feature image. Step S104 may include the following steps.

S141: Perform color space conversion on the first image, to obtain a converted image of a target color space.

The target color space may be set according to an actual requirement. This is not limited in this aspect of this disclosure. For example, the target color space may be a YCbCr color space. A Y-channel of the color space denotes a brightness component of the color, and human eyes are more sensitive to the Y-channel of an image. Therefore, convolution processing is performed after the first image is converted into the target color space, to reduce sensitivity of the human eyes to the Y-channel, so that a change in image quality cannot be perceived by the human eyes.

The color space conversion may be performed on the first image by various conversion technologies. This is not limited in this aspect of this disclosure. In an example, the color space conversion may be performed on the first image through a channel mapping relationship between the color space of the first image and the target color space.

For example, if the color space of the first image is an RGB color space, and the target color space is a YCbCr color space, the first image may be converted from the RGB color space to the YCbCr color space through the channel mapping relationship shown in the following formulas (1) to (3).

$${I}_{Y} = 0.299 \cdot R + 0.587 \cdot G + 0.114 \cdot B ; \qquad ( 1 )$$

$${I}_{C b} = - 0.1687 \cdot R - 0.3313 \cdot G + 0.15 \cdot B + 128 ; and \qquad ( 2 )$$

$${I}_{C r} = 0.5 \cdot R - 0.4187 \cdot G - 0.0813 \cdot B + 128 , \qquad ( 3 )$$

where the first image is denoted as I_{RGB}=[R, G, B], and R, G, and B denote an R-channel image, a G-channel image, and a B-channel image, respectively; and the converted image is denoted as I_{YCbCr}=[I_{Y}, I_{Cb}, I_{Cr}], and I_{Y}, I_{Cb}, and I_{Cr} denote a Y-channel image, a Cb-channel image, and a Cr-channel image, respectively.

In another example, conversion between different color spaces may be regarded as special convolution processing performed along an input channel. Therefore, a corresponding convolution kernel may be configured for the image reconstruction model in advance based on a channel mapping relationship between different color spaces, and then a convolution operation is performed on an input image through the convolution kernel, to implement color space conversion of the input image. Specifically, convolution processing may be performed on the first image through a second convolutional layer of the image reconstruction model, to obtain the converted image of the target color space. The second convolutional layer is determined based on the channel mapping relationship between the color space of the first image and the target color space.

For example, in an example in which the color space of the first image is an RGB color space, and the target color space is a YCbCr color space, the channel mapping relationship shown in the above-mentioned formulas (1) to (3) may be described as convolution processing shown in the following formula (4):

$${I}_{Y C b C r} = {I}_{R G B} \cdot {C}_{1} + {B}_{1} , \qquad ( 4 )$$

where C₁ denotes a parameter of the second convolutional layer,

$${C}_{1} = [ \begin{matrix}0.299 & - 0.1687 & 0.5 \\ 0.587 & - 0.3313 & - 0.4187 \\ 0.114 & 0.5 & - 0.0813\end{matrix} ] ;$$

and B₁ denotes a bias vector, B₁=[0 128 128]^{T}.

Because convolution has better support than a matrix operation, color space conversion of the first image through the second convolutional layer configured for the image reconstruction model occupies less internal memory and is more efficient than another method such as color space conversion based on a matrix operation.

S142: Perform channel separation on the converted image based on a channel parameter of the target color space, to obtain the first-channel image and a second-channel image.

The channel parameter denotes channels constituting the target color space and a value range of each channel.

S143: Perform convolution processing on the second-channel image based on a first convolutional layer of the image reconstruction model, to obtain the first feature image.

For example, if the target color space is a YCbCr color space, channel separation is performed on the converted image to obtain a Y-channel image and a CbCr-channel image. Because human eyes are highly sensitive to the Y-channel, there is a better sense of layering of the Y-channel image. Therefore, the CbCr-channel image may be used as the first-channel image, and the Y-channel image may be used as the second-channel image. Based on this, convolution processing is performed on the second-channel image based on the first convolutional layer, so that more effective features can be extracted, which facilitates subsequent reconstruction of an image with a higher resolution.

To extract effective features in the first image more efficiently and sufficiently, convolution processing may be performed on the second-channel image through two parallel branches. Specifically, the first convolutional layer includes a first convolution subkernel and a second convolution subkernel, and a size of the second convolution subkernel is greater than a size of the first convolution subkernel. Correspondingly, step S143 includes: performing convolution processing on the second-channel image based on the first convolution subkernel, to obtain a first feature subimage; performing convolution processing on the second-channel image based on the second convolution subkernel, to obtain a second feature subimage; and merging the first feature subimage and the second feature subimage, to obtain the first feature image.

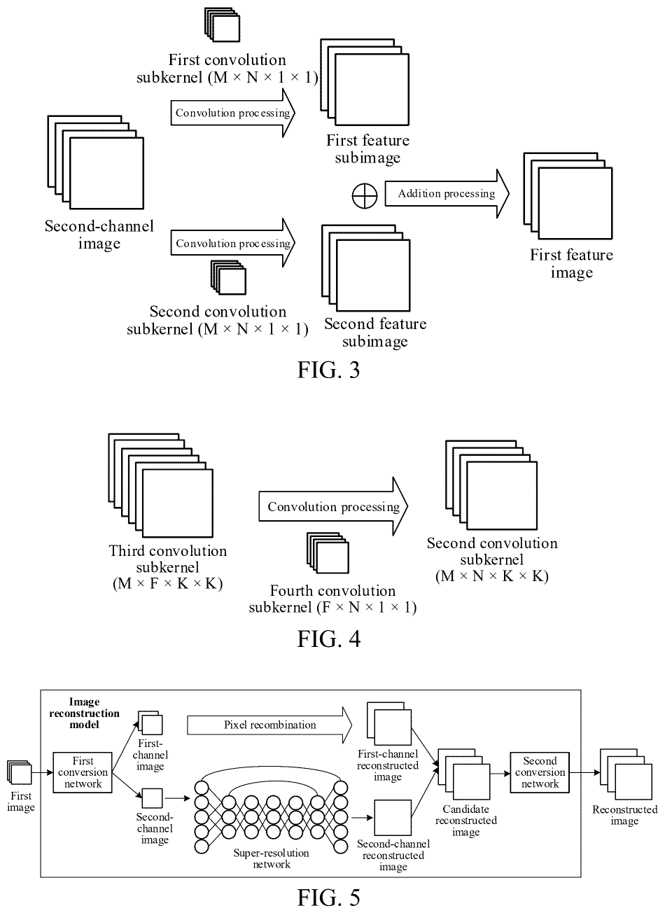

For example, as shown in FIG. 3, the first convolution subkernel is an M×N×1×1 convolution kernel, which denotes that the convolution kernel has a size of 1×1, M input channels, and N output channels. The first convolution subkernel is configured to map the M input channels to the N output channels. The second convolution subkernel is an M×N×K×K convolution kernel, indicating that the convolution kernel has a size of K×K (K is an odd number greater than 1), M input channels is M, and N output channels. The second convolution subkernel is configured to map the M input channels to the N output channels. Convolution processing is performed on the second-channel image with M channels through the first convolution subkernel, as shown in the following formula (5), to obtain a first feature subimage with N channels. In addition, the second-channel image is processed through the second convolution subkernel, as shown in the following formula (6), to obtain a second feature subimage with N channels. Finally, addition processing is performed on the first feature subimage and the second feature subimage, as shown in the following formula (7), to merge the first feature subimage and the second feature subimage, to obtain a first feature image with N channels.

$${Y}_{1 \times 1} = X * {W}_{1 \times 1}^{M \to N} ; \qquad ( 5 )$$

$${Y}_{K \times K} = X * {{W}^{′}}_{K \times K}^{M \to N} ; and \qquad ( 6 )$$

$$Y = {Y}_{1 \times 1} + {Y}_{K \times K} , \qquad ( 7 )$$

where Y_{1×1} denotes the first feature subimage, Y_{K×K} denotes the second feature subimage, Y denotes the first feature image, X denotes the second-channel image,

$${W}_{1 \times 1}^{M \to N}$$

denotes the first convolution subkernel,

$${{W}^{′}}_{K \times K}^{M \to N}$$

denotes the second convolution subkernel, * denotes convolution processing, and + denotes addition processing.

In this aspect of this disclosure, the second convolution subkernel may be constructed by a weight collapse technique, so that during model training, the second convolution subkernel has a complicated update formula in gradient back propagation, thereby improving a training effect of the image reconstruction model. Specifically, the first convolutional layer further includes a third convolution subkernel and a fourth convolution subkernel. The second convolution subkernel is obtained by performing convolution processing on the third convolution subkernel and the fourth convolution subkernel. The third convolution subkernel and the second convolution subkernel are the same in size, and the fourth convolution subkernel and the first convolution subkernel are the same in size. A number of input channels of the third convolution subkernel is the same as a number of input channels of the second convolution subkernel. A number of output channels of the third convolution subkernel is the same as a number of input channels of the fourth convolution subkernel. A number of output channels of the fourth convolution subkernel is the same as a number of output channels of the second convolution subkernel.

For example, as shown in FIG. 4, if the second convolution subkernel has M input channels, N output channels, and a size of K×K, the third convolution subkernel has M input channels, F output channels (F>>N), and a convolution size of K×K, and the fourth convolution subkernel has F input channels, N output channels, and a size is 1×1. The second convolution subkernel is obtained by performing convolution processing on the third convolution subkernel and the fourth convolution subkernel based on the following formula (8):

$${W}_{K \times K}^{′ M \to N} = {W}_{K \times K}^{M \to F} * {W}_{1 \times 1}^{F \to N} , \qquad ( 8 )$$

where,

$${{W}^{′}}_{K \times K}^{M \to N}$$

denotes the second convolution subkernel,

$${W}_{K \times K}^{M \to F}$$

denotes the third convolution subkernel,

$${W}_{1 \times 1}^{F \to N}$$

denotes the fourth convolution subkernel, and * denotes convolution processing.

This aspect of this disclosure herein shows some implementations of step S104. It should be understood that step S104 may alternatively be implemented in another manner. This is not limited in this aspect of this disclosure. For example, no channel division is performed on the first image, but instead, color space conversion is performed on the first image, and then convolution processing is performed on the entire converted image based on the first convolutional layer of the image reconstruction model, to obtain the first intermediate image.

During actual application, steps S141 to S143 may be implemented through different networks of the image reconstruction model. For example, as shown in FIG. 5, the image reconstruction model includes a first conversion network and a super-resolution network. Steps S141 and S142 are implemented through the first conversion network, and step S143 is implemented through the super-resolution network.

Specifically, as shown in FIG. 5, the first image is inputted into the first conversion network. A second convolutional layer in the first conversion network performs color space conversion on the first image, to obtain a converted image of a target color space, and performs channel separation on the converted image, to obtain a first-channel image and a second-channel image. Further, the second-channel image is inputted to the super-resolution network, and the super-resolution network performs convolution processing on the second-channel image based on a pre-configured first convolutional layer, to obtain a first feature image.

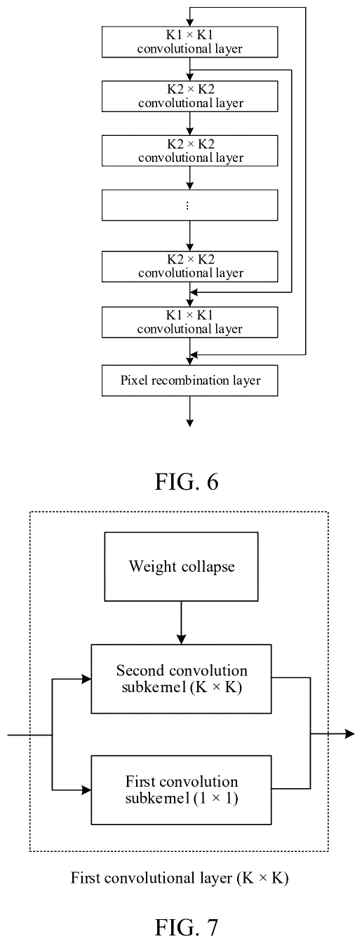

More specifically, as shown in FIG. 6, the super-resolution network includes a plurality of stages of first convolutional layers and a pixel recombination layer. Convolution processing is performed on a second-channel image by the plurality of stages of first convolutional layers to obtain a first feature image, and a reconstructed image of a second channel (referred to as a second-channel reconstructed image below) is obtained after the first feature image is processed by the pixel recombination layer. A first convolutional layer of a corresponding size is built in each stage of first convolutional layer. The size of the first stage of first convolutional layer is equal to the size of the last stage of first convolutional layer (that is, all sizes are K1×K1), and the sizes of intermediate stages of first convolutional layers (that is, all sizes are K2×K2, K2<K1) are equal and are less than the size of the first stage of first convolutional layer. Each stage of first convolutional layer is formed by stacking a first convolution subkernel and a second convolution subkernel, and the second convolution subkernel is implemented by the weight collapse technique described above. For example, as shown in FIG. 7, the first convolutional layer in the K×K convolutional layers may be formed by stacking a first convolution subkernel with a size of 1×1 and a second convolution subkernel with a size of K×K, and the second convolution subkernel with a size of K×K is implemented by the weight collapse technique.

It should be noted that FIG. 5 to FIG. 7 only show a structure of the image reconstruction model. It should be understood that the image reconstruction model may alternatively be of another appropriate structure, which may be specifically arranged according to an actual requirement. This is not limited in this aspect of this disclosure.

S106: Perform pixel recombination on the first intermediate image to obtain a reconstructed image of the first image. For example, pixel recombination is performed on the at least one first intermediate image to obtain a reconstructed image of the first image.

The resolution of the reconstructed image of the first image is higher than that of the first image.

If no channel separation is performed on the first image, step S106 includes the following steps: performing pixel recombination on the first intermediate image, to obtain a candidate reconstructed image, and then performing color space conversion on the candidate reconstructed image, to obtain the reconstructed image of the first image.

In an implementation, to improve the resolution of the reconstructed image, in a case that the first intermediate image includes a first-channel image and a first feature image, step S106 includes the following steps: performing pixel recombination on the first-channel image, to obtain a first-channel reconstructed image; performing pixel recombination on the first feature image, to obtain a second-channel reconstructed image; performing channel merging on the first-channel reconstructed image and the second-channel reconstructed image, to obtain a candidate reconstructed image of the target color space; and performing color space conversion on the candidate reconstructed image, to obtain the reconstructed image of the first image.

Pixel recombination may be performed on the first intermediate image through various pixel recombination algorithms in the art. This is not limited in this aspect of this disclosure. Through the pixel recombination of the first intermediate image, the first intermediate image may be upsampled by a specified multiple (for example, twice, three times, or four times), and the first image may be reconstructed, to obtain a reconstructed image with a high resolution. In this way, any inputted low-resolution image can be mapped to a high-resolution image of a specified multiple.

The color space conversion may be performed on the candidate reconstructed image by various conversion technologies. This is not limited in this aspect of this disclosure. In an example, color space conversion may be performed on the candidate reconstructed image through a channel mapping relationship between the color space of the first image and a target color space.

For example, if the color space of the first image is an RGB color space, and the target color space is a YCbCr color space, the candidate reconstructed image may be converted from the YCbCr color space to the RGB color space through the channel mapping relationship shown in the following formulas (9) to (11), to obtain the reconstructed image of the first image.

$${I}_{R} = Y + 1.402 \cdot ( Cr - 128 ) ; \qquad ( 9 )$$

$${I}_{G} = Y - 0.34414 \cdot ( Cb - 128 ) - 0.71414 \cdot ( Cr - 128 ) ; and \qquad ( 10 )$$

$${I}_{b} = Y + 1.772 \cdot ( Cb - 128 ) , \qquad ( 11 )$$

where the candidate reconstructed image is denoted as I′_{YCbCr}=[Y, Cb, Cr], and Y, Cb, and Cr denote a Y-channel image, a Cb-channel image, and a Cr-channel image, respectively; and the reconstructed image is denoted as I′_{RGB}=[I_{R}, I_{G}, I_{B}], and I_{R}, I_{G}, and I_{B} denote an R-channel image, a G-channel image, and a B-channel image, respectively.

In another example, conversion between different color spaces may be regarded as special convolution processing performed along an input channel. Therefore, a corresponding convolution kernel may be configured for the image reconstruction model in advance based on a channel mapping relationship between different color spaces, and then a convolution operation is performed on an input image through the convolution kernel, to implement color space conversion of the input image. Specifically, convolution processing may be performed on the candidate reconstructed image by a third convolutional layer of the image reconstruction model, to obtain a reconstructed image of the first image. The third convolutional layer is determined based on the channel mapping relationship between the color space of the first image and the target color space.

For example, in an example in which the color space of the first image is an RGB color space, and the target color space is a YCbCr color space, the channel mapping relationship shown in the above-mentioned formulas (9) to (11) may be described as convolution processing shown in the following formula (12):

$${I}_{R G B}^{′} = ( {I}_{Y C b C r}^{′} - {B}_{2} ) \cdot {C}_{2} , \qquad ( 12 )$$

where C₂ denotes a parameter of the third convolutional layer,

$${C}_{2} = [ \begin{matrix}1. & 1. & 1. \\ 0.0 & - 0 \text{.34414} & 1.772 \\ 1.402 & - 0.71414 & 0.0\end{matrix} ] ;$$

and B₂ denotes a bias vector, B₂=[0−128−128]^{T}.

Because convolution has better support than a matrix operation, color space conversion of the candidate reconstructed image through the third convolutional layer configured for the image reconstruction model occupies less internal memory and is more efficient than another method such as color space conversion based on a matrix operation.

During actual application, as shown in FIG. 5, the image reconstruction model may further include a second conversion network. The color space conversion of the candidate reconstructed image may be implemented through the second conversion network. Specifically, as shown in FIG. 5, channel merging are performed on a first-channel reconstructed image and a second-channel reconstructed image to obtain a candidate reconstructed image, and the candidate reconstructed image is inputted to the second conversion network. Color space conversion is performed on the candidate reconstructed image by a third convolutional layer in the second conversion network, to obtain a reconstructed image of the first image.

S108: Train the image reconstruction model based on the reconstructed image of the first image and the second image, to obtain a target image reconstruction model. For example, the image reconstruction model is trained based on the reconstructed image and a second image to obtain a target image reconstruction model. A resolution of the second image is higher than a resolution of the first image. The first image and the second image are based on a same first sample image.

A difference between the reconstructed image of the first image and the second image reflects an effect of image reconstruction performed on the first image through the image reconstruction model. Therefore, the image reconstruction model is trained based on the difference, so that the image reconstruction model can continuously reduce the difference in a reconstruction process, and fully learn an accurate mapping relationship from a low-resolution image to a high-resolution image, thereby improving a reconstruction effect of the image reconstruction model.

In an implementation, step 108 may include the following steps.

S181: Update a model parameter of the image reconstruction model based on the reconstructed image and the second image, to obtain a pretrained image reconstruction model.

For example, a Mean Absolute Error (MAE) between the reconstructed image and the second image is calculated, to obtain a reconstruction loss of the image reconstruction model. Then, a back propagation algorithm is used to update a model parameter of the image reconstruction model with a target of reducing the reconstruction loss. Steps S102 to S181 are repeated for a plurality of times, until a preset training stopping condition is met, to obtain the pretrained image reconstruction model. The training stopping condition may be set according to an actual requirement, for example, a number of iterations reaches a preset number threshold, or a reconstruction loss of the image reconstruction model converges. This is not limited in this aspect of this disclosure.

For another example, the reconstructed image and the second image are converted into the target color space, a Y-channel image is separated from the converted reconstructed image, a Y-channel image is separated from the converted second image, and the model parameter of the image reconstruction model is updated based on a Mean Absolute Error (MAE) between the two Y-channel images. Steps S102 to S181 are repeated for a plurality of times, until a preset training stopping condition is met, to obtain the pretrained image reconstruction model.

S182: Determine the target image reconstruction model based on the pretrained image reconstruction model.

In an example, in step S182, the pretrained image reconstruction model may be used as the target image reconstruction model.

In another example, to adapt the target image reconstruction model to a service requirement, in step S182, a first object image and a second object image are obtained. Then convolution processing is performed on a first region of interest of the first object image through the pretrained image reconstruction model, to obtain a second intermediate image, and pixel recombination is performed on the second intermediate image, to obtain a reconstructed image of the first region of interest. The pretrained image reconstruction model is trained based on the reconstructed image of the first region of interest and a second region of interest of the second object image, to obtain the target image reconstruction model.

The first object image and the second object image are obtained based on a same object image, and a resolution of the second object image is higher than a resolution of the first object image. For example, the first object image may be a low-resolution image obtained by degrading a sample object image, and the second object image may be a high-resolution image obtained by enhancing the sample object image. The sample object image may be a video frame including a sample object and extracted from a high-definition video.

The first region of interest refers to an image region that includes the sample object and that is in the first object image, and the second region of interest refers to an image region that includes the sample object and that is in the second object image.

For example, if a target image reconstruction model applicable to a human face reconstruction scenario is to be obtained, the sample object is a human face, the first object image is a low-resolution human face image, and the second object image is a high-resolution human face image. Key point detection is performed on the first object image, to separately obtain key point data of parts such as eyes, a mouth, a nose, and eyebrows; and Then, a first region of interest (ROI) of the first object image is marked based on the key point data, and coordinate information of the first region of interest is stored. Similarly, a second region of interest of the second object image is marked by performing key point detection on the second object image, and coordinate information of the second region of interest is stored.

Then convolution processing is performed on the first region of interest through the pretrained image reconstruction model based on the coordinate information of the first region of interest, to obtain a second intermediate image, and pixel recombination is performed on the second intermediate image, to obtain a reconstructed image of the first region of interest. Therefore, image reconstruction of the first region of interest is implemented.

Further, a Mean Absolute Error (MAE) between the reconstructed image of the first region of interest and the second region of interest of the second object image is calculated, and a reconstruction loss of the pretrained image reconstruction model is calculated. Then, a back propagation algorithm is used to update a model parameter of the pretrained image reconstruction model with a target of reducing the reconstruction loss. The above-mentioned steps are repeated for a plurality of times, until a preset training stopping condition is met, to obtain a target image reconstruction model.

In the above-mentioned manner, the image reconstruction model is first pretrained through the universal first image and second image, to obtain a pretrained image reconstruction model, and then the pretrained image reconstruction model is trained through the first object image and the second object image in a to-be-applied service scenario. The obtained target image reconstruction model can be better applied to the service scenario, thereby improving an image reconstruction effect of the target image reconstruction model in the service scenario.

In the training method for an image reconstruction model according to one or more aspects of this disclosure, with the low-resolution first image and the high-resolution second image as training data, image reconstruction is performed on the first image through the image reconstruction model, to obtain the reconstructed image, and the image reconstruction model is trained based on the reconstructed image and the second image. Therefore, the image reconstruction model can fully learn a mapping relationship from a low-resolution image to a high-resolution image, and image reconstruction of an image having any resolution can be implemented, to output a high-quality image. Based on this, the image reconstruction model is of a full convolution structure, and mapping from a low-resolution image to a high-resolution image is implemented through convolution processing and pixel recombination of an input image. Because the convolution structure is simple and involves fewer parameters, an image reconstruction process based on a convolution structure has the advantages of high efficiency, low computing complexity, less resource consumption, and light weight. Therefore, the trained target image reconstruction model not only can quickly reconstruct a high-resolution image to meet a requirement on real-time performance, but also consumes fewer resources in an image reconstruction process, is not limited by an application scenario, can not only be run on a server, but also be run on a mobile device with limited computing resources, and can be applied to a special running environment with limited performance, such as a mobile terminal.

The target image reconstruction model trained based on the above-mentioned training method may be deployed on various devices such as a mobile device and a server. If the target image reconstruction model needs to be deployed on a mobile device, the target image reconstruction model may be converted into a corresponding format such as onnx, tflite, or nunn, to facilitate deployment on the mobile device.

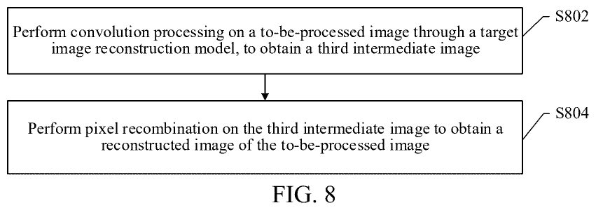

Based on the target image reconstruction model trained through the above-mentioned training method, an aspect of this disclosure further provides an image reconstruction method. FIG. 8 is a schematic flowchart of an image reconstruction method according to an aspect of this disclosure. The method includes the following steps.

S802: Perform convolution processing on a to-be-processed image through a target image reconstruction model, to obtain a third intermediate image. For example, convolution processing is performed on the to-be-processed image through the target image reconstruction model, to obtain at least one second intermediate image.

The to-be-processed image refers to a low-resolution image on which image reconstruction is to be performed. For example, before video calling or during calling, a mobile device loads the target image reconstruction model, and instantiates the target image reconstruction model for real-time super-resolution image reconstruction. During video calling of the mobile device, when a video stream with a low resolution and a low bit rate is received due to a network reason, a VideoFrame object in the video stream is replaced with a bitmap object, which is used as an input of the target image reconstruction model, and the bitmap object is processed through the target image reconstruction model to obtain a high-resolution bitmap object. Therefore, a processor, such as a graphics processing unit (GPU), of the mobile device may be used to implement accelerated computing to ensure real-time performance of processing. Finally, the high-resolution bitmap object is reconverted into a VideoFrame object, which replaces the original VideoFrame object and is displayed on a screen of the mobile device, thereby implementing real-time super-resolution enhancement of the video stream with a low resolution and a low bit rate in a calling scenario of the mobile terminal.

A specific implementation of step S802 is similar to the specific implementation of step S104 in the aspect shown in FIG. 1, and details are not described herein.

S804: Perform pixel recombination on the third intermediate image to obtain a reconstructed image of the to-be-processed image. For example, pixel recombination is performed on the at least one second intermediate image to obtain the reconstructed image.

A specific implementation of step S802 is similar to the specific implementation of step S106 in the aspect shown in FIG. 1, and details are not described herein.

In an implementation, step S804 includes the following steps. S841: Perform color space conversion on the to-be-processed image, to obtain a converted image of a target color space. S842: Perform channel separation on the converted image based on a channel parameter of the target color space, to obtain the third-channel image and a fourth-channel image. S843: Perform convolution processing on the third-channel image and a first convolutional layer of the target image reconstruction model, to obtain the third feature image.

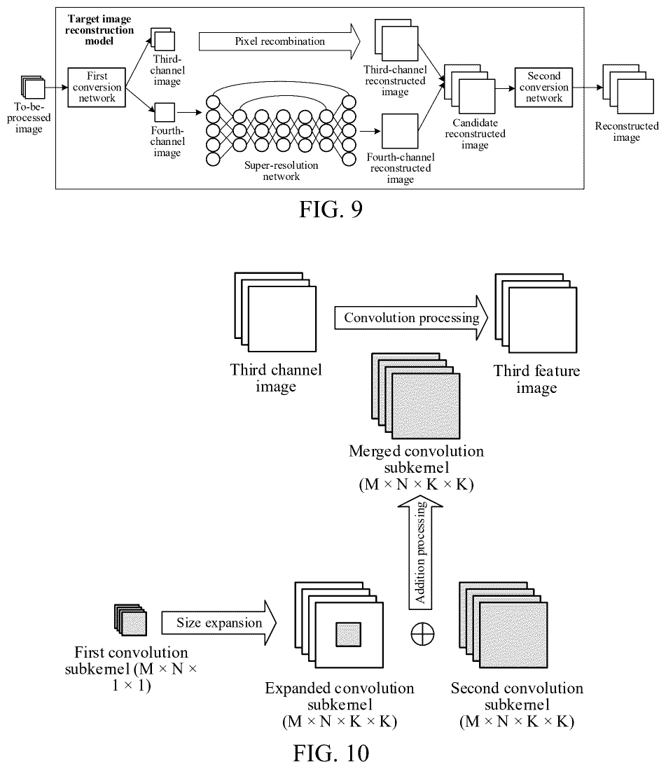

As shown in FIG. 9, the to-be-processed image is inputted into the target image reconstruction model, and a second convolutional layer in the first conversion network performs convolution processing on the to-be-processed image, to implement color space conversion of the to-be-processed image, to obtain a converted image, and performs channel separation on the converted image, to obtain a third-channel image and a fourth-channel image. Further, pixel recombination is performed on the third-channel image, to obtain a third-channel reconstructed image. The fourth-channel image is inputted to a super-resolution network, and the super-resolution network performs convolution processing on the fourth-channel image based on a preconfigured first convolutional layer, to obtain a third feature image. Pixel recombination is performed on the third feature image to obtain a fourth-channel reconstructed image. Further, channel merging is performed on the third-channel reconstructed image and the fourth-channel image to obtain a candidate reconstructed image, and the candidate reconstructed image is inputted into a second conversion network. A third convolutional layer in the second conversion network performs color space conversion on the candidate reconstructed image, to obtain a reconstructed image of the to-be-processed image.

More specifically, the structure of the super-resolution network is shown in FIG. 6, and includes a plurality of stages of convolutional layer and a pixel recombination layer. A first convolutional layer of a corresponding size is built in each stage of convolutional layer, and is formed by stacking a first convolution subkernel and a second convolution subkernel, and the second convolution subkernel is implemented by the weight collapse technique shown in FIG. 7.

In an example, to simplify the structure of each stage of convolutional layer, the second convolution subkernel may be expanded and then merged with the first convolution subkernel, to form an equivalent single branch convolution structure. The single branch convolution structure has both a high-quality processing effect of a parallel branch structure and a high-efficiency processing speed of a single branch structure.

Specifically, the first convolutional layer includes a first convolution subkernel and a second convolution subkernel, and a size of the second convolution subkernel is greater than a size of the first convolution subkernel. Correspondingly, the performing convolution processing on the third-channel image and a first convolutional layer of the target image reconstruction model, to obtain the third feature image includes: performing size expansion on the first convolution subkernel, to obtain an expanded convolution subkernel, where a size of the expanded convolution subkernel is the same as a size of the second convolution subkernel; merging the second convolution subkernel and the expanded convolution subkernel, to obtain a merged convolution subkernel; and performing convolution processing on the third-channel image based on the merged convolution subkernel, to obtain the third feature image.

For example, as shown in FIG. 10, the first convolution subkernel is an M×N×1×1 convolution kernel, and the second convolution subkernel is an M×N×K×K convolution kernel. First, the first convolution subkernel is expanded to a size the same as that of the second convolution subkernel, as shown in the following formula (13), to obtain an expanded convolution subkernel M×N×K×K. Then, addition processing is performed on the expanded convolution subkernel and the second convolution subkernel, as shown in the following formula (14), to obtain a merged convolution subkernel M×N×K×K. Finally, convolution processing is performed on the third-channel image based on the expanded convolution subkernel, to obtain a third feature image. The third feature image has M input channels, N output channels, and a size of K×K.

$${W}_{K \times K}^{′′ M \to N} = expand ( {W}_{1 \times 1}^{M \to N} , K ) ; and \qquad ( 13 )$$

$${W}_{K \times K}^{′′ ′ M \to N} = {W}_{K \times K}^{′ M \to N} + {W}_{K \times K}^{′′ M \to N} , \qquad ( 14 )$$

where

$${W}_{K \times K}^{′′ M \to N}$$

denotes the expanded convolution subkernel,

$${W}_{1 \times 1}^{M \to N}$$

denotes the first convolution subkernel, and expand denotes expansion processing, which makes a weight at a central position in a 1×1 convolution kernel remain unchanged, and adds a value of 0 around for filling until the size of the convolution kernel reaches K×K. This means that weights at positions in

$${W}_{K \times K}^{′′ M \to N}$$

are all 0 except the central position.

$${W}_{K \times K}^{′′ ′ M \to N}$$

denotes the merged convolution subkernel, and

$${W}_{K \times K}^{′ M \to N}$$

denotes the second convolution subkernel.

In the image reconstruction method according to one or more aspects of this disclosure, any image is reconstructed through the target image reconstruction model trained through the above-mentioned training method, to obtain a high-resolution image. Because the target image reconstruction model has a full convolution structure, mapping from a low-resolution image to a high-resolution image is implemented through convolution processing and pixel recombination of an input image. This has the advantages of high efficiency, low computing complexity, less resource consumption, and light weight. This can not only meet a requirement on real-time performance, but also be applied to a special running environment with limited performance, such as a mobile terminal.

Specific aspects of this specification are described above. Other aspects fall within the scope of the appended claims. In some cases, the actions or steps described in the claims may be performed in sequences different from those in the aspects, but an expected result may still be achieved. In addition, the processes depicted in the accompanying drawings is not necessarily performed in the specific order or successively to achieve an expected result. In some implementations, multitasking and parallel processing may also be feasible or beneficial.

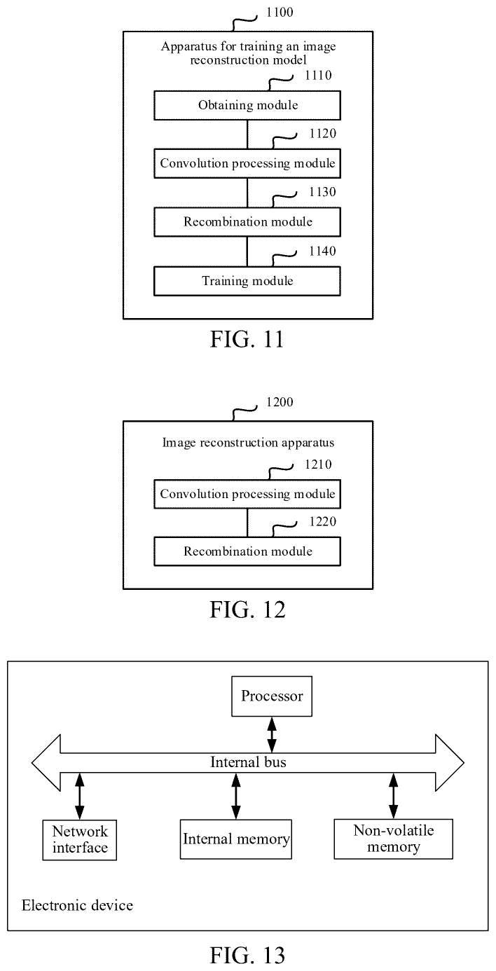

An aspect of this disclosure further provides an apparatus for training an image reconstruction model. FIG. 11 is a schematic structural diagram of an apparatus 1100 for training an image reconstruction model according to an aspect of this disclosure. Referring to FIG. 11, in a software implementation, the apparatus for training an image reconstruction model may include an obtaining module 1110, a convolution processing module 1120, a recombination module 1130, and a training module 1140.

The obtaining module 1110 is configured to obtain a first image and a second image, where the first image and the second image are obtained based on a same image, and a resolution of the second image is higher than a resolution of the first image.

The convolution processing module 1120 is configured to perform convolution processing on the first image through the image reconstruction model, to obtain a first intermediate image.

The recombination module 1130 is configured to perform pixel recombination on the first intermediate image to obtain a reconstructed image of the first image.

The training module 1140 is configured to train the image reconstruction model based on the reconstructed image and the second image, to obtain a target image reconstruction model.

In another aspect, the first intermediate image includes a first-channel image and a first feature image; and
the convolution processing module is configured to:
perform color space conversion on the first image, to obtain a converted image of a target color space;
perform channel separation on the converted image based on a channel parameter of the target color space, to obtain the first-channel image and a second-channel image; and
perform convolution processing on the second-channel image based on a first convolutional layer of the image reconstruction model, to obtain the first feature image.

In another aspect, the first convolutional layer includes a first convolution subkernel and a second convolution subkernel, and a size of the second convolution subkernel is greater than a size of the first convolution subkernel; and
when performing convolution processing on the second-channel image based on a first convolutional layer of the image reconstruction model, to obtain the first feature image, the convolution processing module performs the following steps:
performing convolution processing on the second-channel image based on the first convolution subkernel, to obtain a first feature subimage;
performing convolution processing on the second-channel image based on the second convolution subkernel, to obtain a second feature subimage; and
merging the first feature subimage and the second feature subimage, to obtain the first feature image.

In another aspect, the first convolutional layer further includes a third convolution subkernel and a fourth convolution subkernel. The second convolution subkernel is obtained by performing convolution processing on the third convolution subkernel and the fourth convolution subkernel. The third convolution subkernel and the second convolution subkernel are the same in size, and the fourth convolution subkernel and the first convolution subkernel are the same in size; and
a number of input channels of the third convolution subkernel is the same as a number of input channels of the second convolution subkernel, a number of output channels of the third convolution subkernel is the same as a number of input channels of the fourth convolution subkernel, and a number of output channels of the fourth convolution subkernel is the same as a number of output channels of the second convolution subkernel.

In another aspect, when performing color space conversion on the first image, to obtain a converted image of a target color space, the convolution processing module performs the following steps:
performing convolution processing on the first image through a second convolutional layer of the image reconstruction model, to obtain the converted image of the target color space,
where the second convolutional layer is determined based on a channel mapping relationship between a color space of the first image and the target color space.

In another aspect, the recombination module is configured to:
perform pixel recombination on the first-channel image, to obtain a first-channel reconstructed image;
perform pixel recombination on the first feature image, to obtain a second-channel reconstructed image;
perform channel merging on the first-channel reconstructed image and the second-channel reconstructed image, to obtain a candidate reconstructed image of the target color space; and
perform color space conversion on the candidate reconstructed image, to obtain the reconstructed image of the first image.

In another aspect, the training module is configured to:
update a model parameter of the image reconstruction model based on the reconstructed image and the second image, to obtain a pretrained image reconstruction model; and
determine the target image reconstruction model based on the pretrained image reconstruction model.

In another aspect, when determining the target image reconstruction model based on the pretrained image reconstruction model, the training module performs the following steps:
obtaining a first object image and a second object image, where the first object image and the second object image are obtained based on a same object image, and a resolution of the second object image is higher than a resolution of the first object image;
performing convolution processing on a first region of interest of the first object image through the pretrained image reconstruction model, to obtain a second intermediate image, and performing pixel recombination on the second intermediate image, to obtain a reconstructed image of the first region of interest; and
training the pretrained image reconstruction model based on the reconstructed image of the first region of interest and a second region of interest of the second object image, to obtain the target image reconstruction model.

In another aspect, the first image is obtained by processing the sample image in the following manner:
noise data is added to the sample image, to obtain a noise image;
the noise image is copied to obtain a first noise video;
the first noise video is compressed and coded to obtain a second noise video; and
the first image is generated based on at least one video frame in the second noise video.

The apparatus for training an image reconstruction model according to this aspect of this disclosure can be used as an execution body of the training method for an image reconstruction model shown in FIG. 1. For example, in the training method for an image reconstruction model shown in FIG. 1, step S102 may be performed by the obtaining module 1110 in the apparatus for training an image reconstruction model shown in FIG. 11, step S104 may be performed by the convolution processing module 1120 in the apparatus for training an image reconstruction model shown in FIG. 11, step S106 may be performed by the recombination module 1130 in the apparatus for training an image reconstruction model shown in FIG. 11, and step S108 may be performed by the training module 1140 in the apparatus for training an image reconstruction model shown in FIG. 11.

According to another aspect of this disclosure, modules in the apparatus for training an image reconstruction model shown in FIG. 11 may be separately or wholly merged into one or several other modules, or one (or some) of the modules may be further divided into a plurality of functionally smaller modules. This can implement the same operation without affecting the implementation of technical effects of the aspects of this disclosure. The above-mentioned units are divided based on logical functions. During actual application, a function of one module may alternatively be implemented by a plurality of modules, or functions of a plurality of modules are implemented by one module. In this aspect of this disclosure, the apparatus for training an image reconstruction model may also include other modules. During actual application, these modules may alternatively be cooperatively implemented by other modules, and may be cooperatively implemented by a plurality of modules.

According to another aspect of this disclosure, a computer program (including program code) that can perform steps in the corresponding method shown in FIG. 1 may be run on a universal computing device, such as a computer, which includes a processing element and a storage element such as a central processing unit (CPU), a random access memory (RAM), and a read-only memory (ROM), to construct the apparatus for training an image reconstruction model shown in FIG. 11 and implement the training method for an image reconstruction model according to the aspect of this disclosure. The computer program may be recorded on, for example, a computer-readable storage medium such as a non-transitory computer-readable storage medium, and loaded into an electronic device through the computer-readable storage medium, and run in the electronic device.

An aspect of this disclosure further provides an image reconstruction apparatus. FIG. 12 is a schematic structural diagram of an image reconstruction apparatus 1200 according to an aspect of this disclosure. Referring to FIG. 12, in a software implementation, the image reconstruction apparatus may include a convolution processing module 1210 and a recombination module 1220.

The convolution processing module 1210 is configured to perform convolution processing on a to-be-processed image through a target image reconstruction model to obtain a third intermediate image.

The recombination module 1220 is configured to perform pixel recombination on the third intermediate image to obtain a reconstructed image of the to-be-processed image, where the target image reconstruction model is obtained through training based on the training method for an image reconstruction model according to the aspect of this disclosure.

In another aspect, the third intermediate image includes a third-channel image and a third feature image; and the convolution processing module is configured to:
perform color space conversion on the to-be-processed image, to obtain a converted image of a target color space;
perform channel separation on the converted image based on a channel parameter of the target color space, to obtain the third-channel image and a fourth-channel image; and
perform convolution processing on the third-channel image and a first convolutional layer of the target image reconstruction model, to obtain the third feature image.

In another aspect, the first convolutional layer includes a first convolution subkernel and a second convolution subkernel, and a size of the second convolution subkernel is greater than a size of the first convolution subkernel; and
when performing convolution processing on the third-channel image and a first convolutional layer of the target image reconstruction model, to obtain the third feature image, the convolution processing module executes the following steps:
performing size expansion on the first convolution subkernel, to obtain an expanded convolution subkernel, where a size of the expanded convolution subkernel is the same as a size of the second convolution subkernel;
merging the second convolution subkernel and the expanded convolution subkernel, to obtain a merged convolution subkernel; and performing convolution processing on the third-channel image based on the merged convolution subkernel, to obtain the third feature image.

The image reconstruction apparatus according to this aspect of this disclosure can be used as an execution body of the training method for an image reconstruction model shown in FIG. 8. For example, in the image reconstruction method shown in FIG. 8, step S802 may be performed by the convolution processing module 1210 in the image reconstruction apparatus shown in FIG. 11, and step S104 may be performed by the recombination module 1220 in the image reconstruction apparatus shown in FIG. 12.

According to another aspect of this disclosure, modules in the image reconstruction apparatus shown in FIG. 12 may be separately or wholly merged into one or several other modules, or one (or some) of the modules may be further divided into a plurality of functionally smaller modules. This can implement the same operation without affecting the implementation of technical effects of the aspects of this disclosure. The above-mentioned units are divided based on logical functions. During actual application, a function of one module may alternatively be implemented by a plurality of modules, or functions of a plurality of modules are implemented by one module. In this aspect of this disclosure, the image reconstruction apparatus may also include other modules. During actual application, these modules may alternatively be cooperatively implemented by other modules, and may be cooperatively implemented by a plurality of modules.

According to another aspect of this disclosure, a computer program (including program code) that can perform steps in the corresponding method shown in FIG. 1 may be run on a universal computing device, such as a computer, which includes a processing element and a storage element such as a central processing unit (CPU), a random access memory (RAM), and a read-only memory (ROM), to construct the image reconstruction apparatus shown in FIG. 12 and implement the image reconstruction method according to the aspect of this disclosure. The computer program may be recorded on, for example, a computer-readable storage medium, and loaded into an electronic device through the computer-readable storage medium, and run in the electronic device.

FIG. 13 is a schematic structural diagram of an electronic device according to an aspect of this disclosure. Referring to FIG. 13, from a perspective of hardware, the electronic device includes processing circuitry (for example, a processor), and may further include an internal bus, a network interface, and a memory (for example, a non-transitory computer-readable storage medium). The memory may include an internal memory, such as a random access memory (RAM), or may further include a non-volatile memory, such as at least one disk memory. The electronic device may further include hardware required by another service.

The processor, the network interface, and the memory may be connected to each other through the internal bus. The internal bus may be an industry standard architecture (ISA) bus, a peripheral component interconnect (PCI) bus, an extended industry standard architecture (EISA) bus, or the like. The bus may be classified as an address bus, a data bus, a control bus, or the like. For case of indication, only one bidirectional arrow is used for indication in FIG. 13, but this does not indicate that there is only one bus or only one type of bus.

The memory is configured to store a program. Specifically, the program may include program code, and the program code includes computer operation instructions. The memory may include an internal memory and a non-volatile memory, and provide an instruction and data for the processor.

The processor reads a corresponding computer program from the non-volatile memory into the internal memory and then runs the computer program, to form an apparatus for training an image reconstruction model at a logical level. The processor executes the program stored in the memory, and is specifically configured to perform the following operations:
obtaining a first image and a second image, where the first image and the second image are obtained based on a same image, and a resolution of the second image is higher than a resolution of the first image;
performing convolution processing on the first image through the image reconstruction model, to obtain a first intermediate image;
performing pixel recombination on the first intermediate image to obtain a reconstructed image of the first image; and
training the image reconstruction model based on the reconstructed image and the second image, to obtain a target image reconstruction model.

Alternatively, the processor reads a corresponding computer program from the non-volatile memory into the internal memory and then runs the computer program, to form an image reconstruction apparatus at a logical level. The processor executes the program stored in the memory, and is specifically configured to perform the following operations:
performing convolution processing on a to-be-processed image through a target image reconstruction model, to obtain a third intermediate image, where the target image reconstruction model is obtained through training based on the training method for an image reconstruction model according to the aspect of this disclosure; and
performing pixel recombination on the third intermediate image to obtain a reconstructed image of the to-be-processed image.

The method performed by the apparatus for training an image reconstruction model disclosed in the aspect shown in FIG. 1 of this disclosure or the method performed by the image reconstruction apparatus disclosed in the aspect shown in FIG. 8 of this disclosure may be applied to a processor, or may be implemented by a processor. The processor may be an integrated circuit chip, and has a signal processing capability. In an implementation process, the steps of the above-mentioned method may be completed through an integrated logic circuit of hardware or an instruction in a form of software in the processor. The processor may be a general-purpose processor, including processing circuitry, such as a central processing unit (CPU), a network processor (NP), or the like. Alternatively, the processor may be a digital signal processor (DSP), an application-specific integrated circuit (ASIC), a field-programmable gate array (FPGA), or another programmable logic device, discrete gate or transistor logic device, or discrete hardware component. The processor may implement or perform the methods, the steps, and logic block diagrams that are disclosed in the aspects of this disclosure. The general-purpose processor may be a microprocessor, or the processor may be any conventional processor or the like. The steps of the methods disclosed with reference to the aspects of this disclosure may be directly performed and completed through a hardware decoding processor, or may be performed and completed through a combination of hardware and software modules in the decoding processor. The software module may be stored in a storage medium that is mature in the art, such as a random access memory, a flash memory, a read-only memory, a programmable read-only memory, an electrically erasable programmable memory, or a register. The storage medium is located in the memory. The processor reads information in the memory and completes the steps of the methods in combination with hardware thereof.

The electronic device may further perform the method in FIG. 1, and implement functions of the apparatus for training an image reconstruction model in the aspects shown in FIG. 1 to FIG. 7. Alternatively, the electronic device may further perform the method in FIG. 8, and implement functions of the image reconstruction apparatus in the aspects shown in FIG. 8 to FIG. 10. Details are not described herein in this aspect of this disclosure.

In addition to software implementations, another implementation is not excluded in the electronic device according to this disclosure, for example, a logic device or a combination of hardware and software. In other words, an execution body of the following processing procedures is not limited to logical units, and may alternatively be hardware or a logic device.

An aspect of this disclosure further provides a computer-readable storage medium. The computer-readable storage medium stores one or more programs, and the one or more programs include instructions. The instructions enable, when executed by a portable electronic device including multiple application programs, the portable electronic device to perform the method in the aspect shown in FIG. 1, and are specifically configured to perform the following operations:
obtaining a first image and a second image, where the first image and the second image are obtained based on a same image, and a resolution of the second image is higher than a resolution of the first image;
performing convolution processing on the first image through the image reconstruction model, to obtain a first intermediate image;
performing pixel recombination on the first intermediate image to obtain a reconstructed image of the first image; and
training the image reconstruction model based on the reconstructed image and the second image, to obtain a target image reconstruction model.

Alternatively, the one or more programs include instructions. The instructions enable, when executed by a portable electronic device including multiple application programs, the portable electronic device to perform the method in the aspect shown in FIG. 8, and are specifically configured to perform the following operations:
performing convolution processing on a to-be-processed image through a target image reconstruction model, to obtain a third intermediate image, where the target image reconstruction model is obtained through training based on the training method for an image reconstruction model according to the aspect of this disclosure; and
performing pixel recombination on the third intermediate image to obtain a reconstructed image of the to-be-processed image.

An aspect of this disclosure further provides a computer program product, including a non-transitory computer-readable storage medium storing a computer program, where the computer program is operable to cause a computer to perform some or all steps in the training method for an image reconstruction model or in the image reconstruction method according to the aspect of this disclosure.

To sum up, the above mentioned are only example aspects of this disclosure and are not intended to limit the protection scope of this disclosure. Any modification, equivalent replacement, or improvement made without departing from the spirit and principle of this disclosure shall fall within the protection scope of this disclosure.

The system, the apparatus, the module, or the unit described in the above-mentioned aspects may be specifically implemented by a computer chip or an entity, or implemented by a product having a function. A typical implementation device is a computer. Specifically, for example, the computer may be a personal computer, a laptop computer, a cellular phone, a camera phone, a smartphone, a personal digital assistant, a media player, a navigation device, an email device, a game console, a tablet computer, a wearable device, or a combination of any of these devices.

Computer-readable media include permanent media and non-permanent media, removable media and non-removable media, which may implement storage of information through any method or technology. The information may be a computer-readable instruction, a data structure, a program module, or other data. Examples of the computer storage medium include, but are not limited to, a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium may be configured to store information that can be accessed by a computing device. Based on the definition in this specification, the computer-readable medium does not include transitory computer-readable media (transitory media) such as a modulated data signal and carrier.

It should be further noted that the terms “include”, “comprise”, or any other variants thereof are intended to cover a non-exclusive inclusion, so that a process, method, product, or device that includes a list of elements not only includes those elements but further includes other elements that are not expressly listed, or further includes elements inherent to such a process, method, product, or device. Unless otherwise specified, an element defined by “include a/an . . . ” does not exclude other same elements related in the process, method, product, or device that includes the element.

The aspects of this specification are all described in a progressive manner. For same or similar parts in the aspects, reference may be made to these aspects, and descriptions of each aspect focus on a difference from other aspects. For example, a system aspect is basically similar to a method aspect, and therefore is described briefly. For examples of related parts. reference may be made to partial descriptions in the method aspect.

What is claimed is:

1. A method for training an image reconstruction model, the method comprising:
performing convolution processing on a first image through the image reconstruction model to obtain at least one first intermediate image;
performing pixel recombination on the at least one first intermediate image to obtain a reconstructed image of the first image; and
training the image reconstruction model based on the reconstructed image and a second image to obtain a target image reconstruction model, wherein a resolution of the second image is higher than a resolution of the first image, the first image and the second image are based on a same first sample image.

2. The method according to claim 1, wherein
the at least one first intermediate image includes a first-channel image and a first feature image; and
the performing the convolution processing on the first image comprises:
converting a color space of the first image to obtain a converted image in a target color space;
separating channels of the converted image based on channel parameters of the target color space to obtain the first-channel image and a second-channel image; and
performing convolution processing on the second-channel image based on a first convolutional layer of the image reconstruction model to obtain the first feature image.

3. The method according to claim 2, wherein the converting the color space of the first image comprises:
performing the convolution processing on the first image through a second convolutional layer of the image reconstruction model to obtain the converted image of the target color space,
wherein the second convolutional layer is based on a channel mapping relationship between a color space of the first image and the target color space.

4. The method according to claim 2, wherein the performing the pixel recombination on the at least one first intermediate image comprises:
performing pixel recombination on the first-channel image to obtain a first-channel reconstructed image;
performing pixel recombination on the first feature image to obtain a second-channel reconstructed image;
merging the first-channel reconstructed image and the second-channel reconstructed image to obtain a candidate reconstructed image in the target color space; and
converting a color space of the candidate reconstructed image to obtain the reconstructed image of the first image.

5. The method according to claim 1, wherein the training the image reconstruction model comprises:
updating model parameters of the image reconstruction model based on the reconstructed image and the second image to obtain the target image reconstruction model.

6. The method according to claim 5, wherein the updating the model parameters comprises:
obtaining a third image based on a second sample image;
obtaining a fourth image based on the second sample image, a resolution of the fourth image being higher than a resolution of the third image;
performing convolution processing on a first region of interest of the third image through the image reconstruction model to obtain a second intermediate image;
performing pixel recombination on the second intermediate image to obtain a reconstructed image of the first region of interest; and
updating the model parameters of the image reconstruction model based on the reconstructed image of the first region of interest and a second region of interest of the fourth image.

7. The method according to claim 1, comprising:
adding noise data to the first sample image from which the first image is obtained to obtain a noise image;
duplicating the noise image to obtain a first noise video;
encoding the first noise video to obtain a second noise video; and
generating the first image based on at least one video frame in the second noise video.

8. The method according to claim 2, wherein
the first convolutional layer includes:
a first convolution subkernel, and
a second convolution subkernel of a size that is greater than a size of the first convolution subkernel; and
feature maps generated by the first convolution subkernel and the second convolution subkernel are merged to obtain the first feature image.

9. The method according to claim 8, wherein the second convolution subkernel is obtained by performing convolution processing on a third convolution subkernel with a fourth convolution subkernel.

10. The method according to claim 1, wherein the image reconstruction model comprises:
a first conversion network that performs first color space conversion and channel separation;
a super-resolution network that performs convolution processing; and
a second conversion network that performs second color space conversion to obtain the reconstructed image.

11. An image reconstruction method, comprising:
obtaining a to-be-processed image;
inputting the to-be-processed image into a target image reconstruction model; and
obtaining a reconstructed image from the target image reconstruction model based on the to-be-processed image, a resolution of the reconstructed image being higher than a resolution of the to-be-processed image, wherein
the target image reconstruction model is trained by:
performing convolution processing on a first image through an image reconstruction model to obtain at least one first intermediate image;
performing pixel recombination on the at least one first intermediate image to obtain a reconstructed image of the first image; and
training the image reconstruction model based on the reconstructed image and a second image to obtain the target image reconstruction model, wherein a resolution of the second image is higher than a resolution of the first image, the first image and the second image are based on a same first sample image.

12. The method according to claim 11, wherein the obtaining the reconstructed image comprises:
performing convolution processing on the to-be-processed image through the target image reconstruction model, to obtain at least one second intermediate image;
performing pixel recombination on the at least one second intermediate image to obtain the reconstructed image.

13. The method according to claim 12, wherein
the at least one second intermediate image includes a first-channel image and a feature image; and
the performing the convolution processing on the to-be-processed image comprises:
converting a color space of the to-be-processed image to obtain a converted image in a target color space;
separating channels of the converted image based on channel parameters of the target color space to obtain the first-channel image and a second-channel image; and
performing convolution processing on the second-channel image based on a first convolutional layer of the target image reconstruction model to obtain the feature image.

14. The method according to claim 13, wherein the first convolutional layer includes a first convolution subkernel and a second convolution subkernel, a size of the second convolution subkernel being greater than a size of the first convolution subkernel; and
the performing the convolution processing on the second-channel image comprises:
expanding the size of the first convolution subkernel to match the size of the second convolution subkernel to obtain an expanded convolution subkernel;
merging the second convolution subkernel and the expanded convolution subkernel to obtain a merged convolution subkernel; and
performing the convolution processing on the second-channel image based on the merged convolution subkernel to obtain the feature image.

15. The method according to claim 11, wherein model parameters of the image reconstruction model are updated based on the reconstructed image and the second image to obtain the target image reconstruction model.

16. An information processing apparatus, comprising:
processing circuitry configured to:
obtain a to-be-processed image;
input the to-be-processed image into a target image reconstruction model; and
obtain a reconstructed image from the target image reconstruction model based on the to-be-processed image, a resolution of the reconstructed image being higher than a resolution of the to-be-processed image, wherein
the target image reconstruction model is trained by:
performing convolution processing on a first image through an image reconstruction model to obtain at least one first intermediate image;
performing pixel recombination on the at least one first intermediate image to obtain a reconstructed image of the first image; and
training the image reconstruction model based on the reconstructed image and a second image to obtain the target image reconstruction model, wherein a resolution of the second image is higher than a resolution of the first image, the first image and the second image are based on a same first sample image.

17. The information processing apparatus according to claim 16, wherein the processing circuitry is configured to:
perform convolution processing on the to-be-processed image through the target image reconstruction model, to obtain at least one second intermediate image;
perform pixel recombination on the at least one second intermediate image to obtain the reconstructed image.

18. The information processing apparatus according to claim 17, wherein
the at least one second intermediate image includes a first-channel image and a feature image; and
the processing circuitry is configured to:
convert a color space of the to-be-processed image to obtain a converted image in a target color space;
separate channels of the converted image based on channel parameters of the target color space to obtain the first-channel image and a second-channel image; and
perform convolution processing on the second-channel image based on a first convolutional layer of the target image reconstruction model to obtain the feature image.

19. The information processing apparatus according to claim 18, wherein the first convolutional layer includes a first convolution subkernel and a second convolution subkernel, a size of the second convolution subkernel being greater than a size of the first convolution subkernel; and
the processing circuitry is configured to:
expand the size of the first convolution subkernel to match the size of the second convolution subkernel to obtain an expanded convolution subkernel;
merge the second convolution subkernel and the expanded convolution subkernel to obtain a merged convolution subkernel; and
perform the convolution processing on the second-channel image based on the merged convolution subkernel to obtain the feature image.

20. The information processing apparatus according to claim 16, wherein model parameters of the image reconstruction model are updated based on the reconstructed image and the second image to obtain the target image reconstruction model.
